(19) United States
(12) Patent Application Publication
(10) Pub. No.: US 2020/0185933 A1
(43) Pub. Date: Jun. 11, 2020

(54) A SYSTEM FOR EFFICIENT CHARGING OF DISTRIBUTED BATTERIES

(71) Applicant: ALELION ENERGY SYSTEMS AB, GOETEBORG (SE)

(72) Inventor: Roland GERSCH, Munich (DE)

(73) Assignee: ALELION ENERGY SYSTEMS AB, GOETEBORG (SE)

(21) Appl. No.: 16/085,834

(22) PCT Filed: Mar. 18, 2016
(86) PCT No.: PCT/EP2016/055984

§ 371 Date: Sep. 17, 2018

(51) Int. Cl. H02J 7/00; H02J 7/04; H02J 3/32; B60L 53/63

(52) U.S. Cl. CPC H02J 7/0019; H02J 7/0071; H02J 7/04; B60L 53/63; H02J 3/322; H02J 7/0047; H02J 7/00032

(57) ABSTRACT

A system and method for efficient charging of distributed batteries each connected to a power supply grid via a low-frequency switch of a switching battery controller communicating with a control center adapted to provide a switching schedule for the low-frequency switch of the respective switching battery controller on the basis of power absorption predictions calculated by said control center for the switching battery controllers in response to power measurements reported by the switching battery controllers and on the basis of power absorption schedules and/or power generation schedules of energy resources of said power supply grid.

The invention relates to a system and a method for efficient charging of distributed batteries connected to a power supply grid.

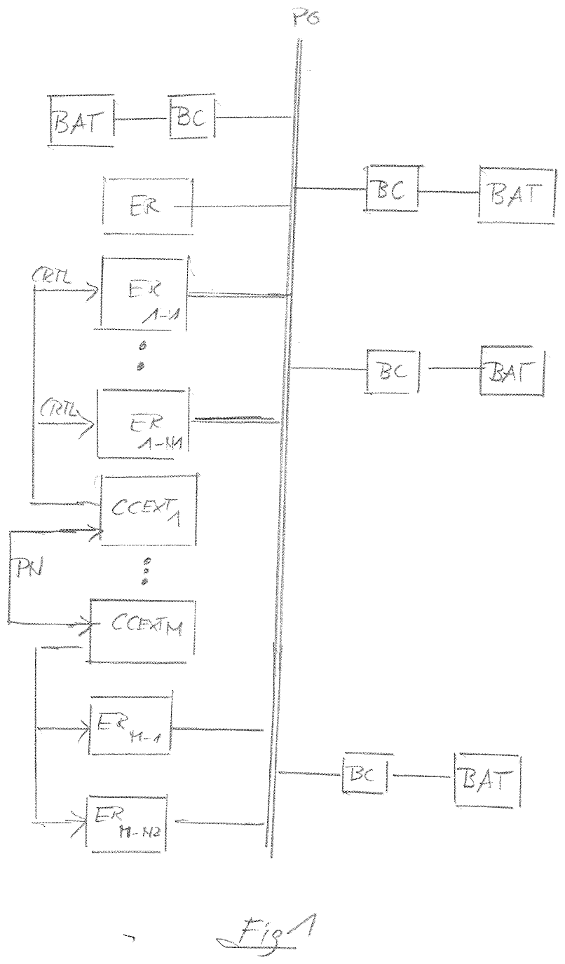

FIG. 1 shows a conventional power supply grid PG. As can be seen in FIG. 1, a plurality of distributed batteries BAT is connected to the power supply grid PG by means of a battery charger BC. The battery chargers extract energy or power from the power supply grid to charge the respective battery BAT. Further, also other consumers can be connected to the power supply grid PG (not shown in FIG. 1). A plurality of different energy resources ER are connected to the power supply grid as shown in FIG. 1. An energy resource can be a controllable power consumer, controllable power generator or a controllable device for storing energy. In the exemplary European power transmission grid, most of the energy resources are controlled by external control centers CCEXT. In the example, these control centers CCEXT are control centers of power plant operators. There can be different power plant operators each running a number of energy resources ER as shown in FIG. 1. In the example of the European power transmission grid, energy resources ER comprise renewable energy resources such as wind turbines or photovoltaic power generation plants, conventional energy resources such as gas turbine power plants as well as batteries. The different control centers CCEXTi of the different energy resources can be connected to each other by means of a private network PN to communicate with each other. To stabilize the power supply grid PG normally grid parameters such as local voltage and grid-wide frequency can be measured. An alternating current power supply grid PG usually has a predetermined operation frequency. This operation frequency is for instance in the European transmission grid 50 Hz. If the operation frequency of the power supply grid PG drops beneath a predetermined threshold value additional energy resources ER are activated to stabilize the power supply grid, predetermined, already active energy resources increase their electrical power supply to or decrease their power consumption from the power supply grid. On the contrary, if the operation frequency of the power supply grid becomes too high energy resources are deactivated, reduce their electrical power supply to or increase their power consumption from the power supply grid in order to stabilize the power supply grid.

A drawback of the conventional power supply system as illustrated in FIG. 1 is that it is necessary to provide flexible energy resources to stabilize the power supply grid in response to a changing energy demand of a plurality of consumers. With increasing electromobility, the number of batteries BAT connected to the power supply grid PG does increase significantly. The batteries BAT can comprise batteries of vehicles comprising cars and trucks having electric motors powered by the energy stored in the batteries BAT of the vehicle. In the conventional power supply system, a plurality of different vehicle owners may try to load their respective batteries BAT at the same time. To balance this potential peak power demand, a conventional power supply system has to provide many matching flexible energy resources which can be activated on short notice in case that a peak power supply demand occurs to stabilize the power supply grid.

Accordingly, it is an object of the present invention to provide a method and a system for efficient charging of distributed batteries allowing to reduce the necessary power supply capacity provided by flexible energy resources.

An advantage of the present invention is that it can accomplish the efficient charging of batteries without requiring the charging devices to also be discharging devices.

This object is achieved by a system for efficient charging of distributed batteries comprising the features of claim 1.

The invention provides according to a first aspect a system for efficient charging of distributed batteries each connected to a power supply grid via a low-frequency switch of a switching battery controller communicating with a control center adapted to provide a switching schedule for the low-frequency switch of the respective switching battery controller on the basis of power absorption predictions calculated by said control center for the switching battery controllers in response to power measurements reported by the switching battery controllers and on the basis of power absorption schedules and/or power generation schedules of energy resources of the power supply grid.

In a possible embodiment of the system according to the first aspect of the present invention, the control center is adapted to determine the switching schedule for the low-frequency switch of the switching battery controller in response to the calculated power absorption predictions, the power absorption schedules and/or power generation schedules of the energy resources and in response to the monitored power grid parameters.

In a possible embodiment of the system according to the first aspect of the present invention, the switching battery controller comprises a processor adapted to communicate with said control center via a communication interface of the switching battery controller and adapted to control the low-frequency switch of the switching battery controller according to the switching schedule determined by the control center for the low-frequency switch of the switching battery controller and received by said processor through the communication interface of the switching battery controller.

In a further possible embodiment of the system according to the first aspect of the present invention, the switching battery controller comprises a metering unit adapted to measure a current power absorbed by a battery charger connected to the low-frequency switch of the switching battery controller and to report the measured power absorption to the control center which is adapted to calculate power absorption predictions based on previously reported power absorptions.

In a further possible embodiment of the system according to the first aspect of the present invention, the control center is adapted to calculate power absorption predictions for a specific time period by evaluating previously reported absorptions of at least one corresponding time period in the past reported under matching circumstances.

In a further possible embodiment of the system according to the first aspect of the present invention, the control center is connected to at least one external control center of energy resources to receive planned power absorption schedules and/or power generation schedules for the energy resources controlled by the respective external control center.

In a further possible embodiment of the system according to the first aspect of the present invention, the control center is adapted to calculate for at least one monitored power grid parameter a power absorption schedule and/or power generation schedule for the batteries based on the deviation from a predetermined parameter target value of the at least one monitored power grid parameter.

In a further possible embodiment of the system according to the first aspect of the present invention, the control center is adapted to receive duty power absorption schedules for the entirety of batteries from at least one external control center.

In a further possible embodiment of the system according to the first aspect of the present invention, the control center is adapted to calculate switching schedules against planned power absorption schedules and/or power generation schedules for energy resources, duty power absorption and/or power generation schedules for the batteries and/or power absorption schedules and/or power generation schedules for the batteries based on a deviation from a predetermined parameter target value of at least one monitored power grid parameter.

In a further possible embodiment of the system according to the first aspect of the present invention, the control center is adapted to sum up at least one of the planned power absorption schedules and/or power generation schedules for the energy resources controlled by at least one external control center, all the duty power absorption and/or power generation schedules for the batteries, the power absorption schedules and/or power generation schedules for the batteries based on a deviation from a predetermined parameter target value of at least one monitored power grid parameter to calculate a candidate schedule.

In a further possible embodiment of the system according to the first aspect of the present invention, the control center is adapted to predict the power absorption and/or power generation of the entirety of batteries connected to the control center based on a candidate schedule.

In a further possible embodiment of the system according to the first aspect of the present invention, the control center is adapted to optimize the calculated candidate schedule on the basis of a utility of energy stored in the distributed batteries and/or life expectancy impacts of charging processes on the distributed batteries by varying the at least one planned power absorption schedule and/or power generation schedule for the energy resources controlled by the at least one external control center included in the summation.

In a further possible embodiment of the system according to the first aspect of the present invention, the low-frequency switch of a switching battery controller is an electromechanical switch.

In a further possible embodiment of the system according to the first aspect of the present invention, the distributed batteries comprise rechargeable batteries of electric vehicles.

In a further possible embodiment of the system according to the first aspect of the present invention, the metering units of the switching battery controllers are connected via a communication infrastructure to a virtual meter of the central controller.

The invention further provides according to a second aspect a method for efficient charging of distributed batteries comprising the features of claim 15.

The invention provides according to the second aspect a method for efficient charging of distributed batteries each connected to a power supply grid via a low-frequency switch of a switching battery controller, the method comprising the steps of:

calculating by a control center for all switching battery controllers power absorption predictions in response to power measurements reported by the switching battery controllers to the control center; and
controlling the low-frequency switch of a switching battery controller according to a switching schedule determined for the respective low-frequency switch by said control center on the basis of the predicted power absorption and on the basis of power absorption and/or power generation schedules of energy resources of said power supply grid.

The invention further provides according to a third aspect a switching battery controller for a rechargeable battery comprising the features of claim 16.

The invention provides according to the third aspect a switching battery controller for a rechargeable battery, said switching battery controller comprising:

a low-frequency switch connectable to a battery charger of said rechargeable battery,
a processor adapted to control the low-frequency switch according to a switching schedule received from a control center by a communication interface of said switching battery controller and
a metering unit adapted to measure a current power absorbed by the battery charger and to report the measured power absorption via the communication interface of said switching battery controller to said control center.

In a possible embodiment of the switching battery controller according to the third aspect of the invention, the metering unit is adapted to measure the deviation of at least one grid parameter from the grid parameter target value and the processor is adapted to control the low-frequency switch according to a threshold value for the deviation of the at least one grid parameter from the grid parameter target value.

The invention further provides according to a fourth aspect a control center comprising the features of claim 17.

The invention provides according to the fourth aspect a control center for a system according to the first aspect of the present invention, wherein said control center is adapted to provide a switching schedule for different switching battery controllers on the basis of power absorption predictions calculated by said control center for all switching battery controllers in response to power measurements reported by the switching battery controllers and on the basis of power absorption and/or generation schedules of energy resources of said power supply grid.

In a possible embodiment of the control center according to the fourth aspect of the invention, the control center is adapted to provide threshold values for the deviation of at least one grid parameter from the grid parameter target value to a multitude of the switching battery controllers.

In the following, possible embodiments of the different aspects of the present invention are described in more detail with reference to the enclosed figures.

FIG. 1 shows a block diagram of a conventional power supply system for illustrating a problem underlying the present invention;

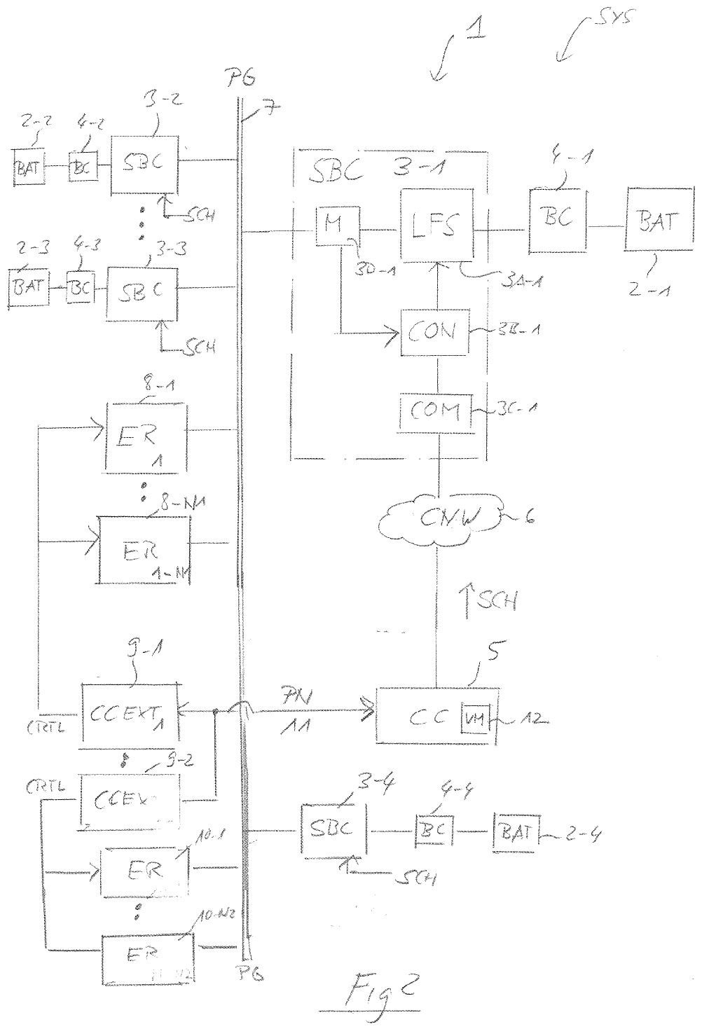

FIG. 2 shows a block diagram of a possible exemplary embodiment of a system for efficient charging of distributed batteries according to the first aspect of the present invention;

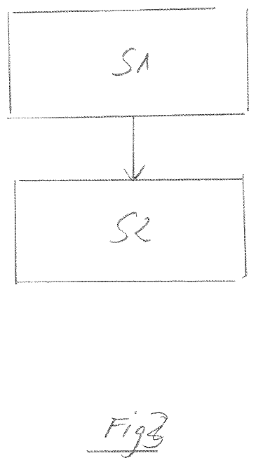

FIG. 3 shows a flowchart of a possible exemplary embodiment of a method for efficient charging of distributed batteries according to a further aspect of the present invention.

As can be seen in FIG. 2, a system 1 for efficient charging of distributed batteries 2-1, 2-2, 2-3, 2-4 can comprise a number of switching battery controllers 3-1, 3-2, 3-3, 3-4. The batteries 2-i can be connected to an associated switching battery controller 3-i by means of a battery charger 4-i as shown in FIG. 2. In the illustrated embodiment of FIG. 2, the switching battery controller 3-i comprises a low-frequency switch, a processor, a metering unit and a communication interface. The switching battery controller 3-1 as illustrated in FIG. 2 is expanded to show its internal structure which comprises a low-frequency switch 3A-1, a processor 3B-1, a communication interface 3C-1 and a metering unit 3D-1. The processor 3B of a switching battery controller (SBC) 3 is adapted to control the low-frequency switch 3A of the respective switching battery controller 3. Further, the processor 3B is adapted to communicate with a control center 5 via a communication interface 3C of the switching battery controller 3. The communication interface 3C is connected via a communication network 6 to the communication center 5. The communication network 6 can for instance be a communication data network such as the internet. In an alternative embodiment, the communication network 6 can be formed by a telephone network. In a still further possible embodiment, the communication network can also be formed by the powerlines of a power supply grid using powerline communication PLC. As shown in FIG. 2, a plurality of switching battery controllers 3-i can be connected to powerlines of a common power supply grid 7 adapted to supply power to a plurality of power consuming devices including a plurality of distributed batteries to be loaded. As can be seen in FIG. 2, the power supply grid 7 can receive power from energy resources 8-1, 8-n1 controlled by a first external control center 9-1 and from a second group of energy resources 10-1 to 10-n2 controlled by another external control center 9-2. The external control centers 9-1, 9-2 can be for instance control centers of different power plant operators. The energy resources 8, 10 can comprise renewable and non-renewable energy resources. In the embodiment illustrated in FIG. 2, the external control centers 9-1, 9-2 are connected via a private communication network 11 to exchange data.

In the system 1 shown in FIG. 2, a plurality of distributed batteries 2-i are connected to the power supply grid 7 via a low-frequency switch 3A of the switching battery controller 3. The switching battery controller 3 is adapted to communicate with the control center 5 of the system 1 via the communication interface 3C and the communication network 6. The control center 5 is adapted to provide a switching schedule SCH for the low-frequency switch 3A of the switching battery controller 3 on the basis of power absorption predictions calculated by the control center 5 for the switching battery controllers 3 in response to power measurements reported by the switching battery controllers 3 and on the basis of power absorption schedules and/or power generation schedules of energy resources 8, 10 connected to the power supply grid 7. As shown in FIG. 2, the control center 5 is connected to the external communication centers 9-1, 9-2 by means of the private communication network 11. Based on all information data received and predicted, the communication center 5 is adapted to calculate an optimal switching schedule SCH for the different switching battery controllers 3 and to supply the calculated switching schedule SCH to the different switching battery controllers 3 via the same or different communication networks 6 as illustrated in FIG. 2. The control center 5 can send the calculated switching schedule SCH over the communication network 6 to the communication interface 3C of the switching battery controller 3 from where it is forwarded to the processor 3B of the switching battery controller 3. In a preferred embodiment, the control center 5 has access to measurements and forecasts regarding the environment of the power supply system, in particular temperature, wind strength, cloud cover or rainfall. Further, the communication center 5 can have access to measurements regarding the grid status of the power supply grid 7, in particular the grid operation frequency and/or a root-mean-square voltage. The control center 5 is adapted to determine the switching schedule SCH for the low-frequency switches 3A of the different switching battery controllers 3 in response to calculated power absorption predictions, power absorption schedules and/or in response to power generation schedules of the energy resources 8, 10 and/or in response to monitored power grid parameters of the power supply grid 7. The schedules of the energy resources 8, 10 can be received from the external control centers 9-1, 9-2 by the control center 5 via the private network 11.

The processor 3B of a switching battery controller 3 is adapted to control the low-frequency switch 3A of the switching battery controller 3 according to the received switching schedule SCH received from the control center 5 for the respective low-frequency switch 3A of the switching battery controller 3. In a possible embodiment, the low-frequency switch 3A controlled by the processor 3B is formed by an electromechanical switch. The low-frequency switch 3A is adapted to separate the battery charger 4 from the power supply grid 7 when opened or switched off. The low-frequency switch 3A can be in a possible implementation a switch which is able to open between once every 10 seconds and once every 15 minutes. This is a low-switching frequency compared to conventional switches for battery charging which may open or even invert several thousand times per second. Consequently, the low-frequency switch 3A used within the switching battery controller 3 can be implemented by a switch of a simpler type, for instance a electromechanical switch instead of a semiconducting switch, thus reducing the necessary complexity of the switching battery controller 3. The low switching frequency also makes the use of electromagnetic filters to control the harmonics of the switching action unnecessary.

The switching battery controller 3 further comprises a metering unit 3D adapted to measure a current power absorbed by the battery charger 4 connected to the low-frequency switch 3A of the switching battery controller 3. The metering unit 3D is further adapted to report the measured power absorption to the control center 5 which is adapted to calculate power absorption predictions based on previously reported power absorptions. The metering unit 3D measures the current power absorbed by the battery charger 4 and sends the measured current power value to the local controller or processor of the switching battery controller 3. The processor 3B of the switching battery controller 3 does then send the measured current absorbed power via the communication network 6 to the control center 5. Accordingly, the control center 5 receives from a plurality of different switching battery controllers 3-i reported measured power absorption values and can calculate power absorption predictions based on the received reported power absorptions. In a preferred embodiment, the control center 5 comprises a processing unit which is adapted to calculate power absorption predictions for a specific time period by evaluating previously reported absorptions of at least one corresponding time period in the past reported under matching circumstances. For instance the control center 5 can be adapted to calculate power absorption predictions based on previously reported power absorption measurements by extrapolating patterns from comparable days of the week, comparable weather conditions and/or comparable weeks within the same year. In a possible implementation, the control center 5 can copy the power absorption pattern from the same day of a week, within the same week of a year from a previous year, except if the temperature T at the time was more than e.g. 5 degrees different than the current temperature T. In this case, the control center 5 could copy the pattern from the previous or next week of the year whichever one has the most similar temperature. Accordingly, the control center 5 used within the system according to the present invention comprises a predictive capability providing an advantage because this allows the connection of different types and sizes of batteries 2-i and battery chargers 4 without having to develop an optimization algorithm for each type and size of batteries and battery chargers.

The control center 5 is connected to the at least one external control centers 9-1, 9-2 of energy resources 8, 10 to receive planned power absorption schedules and/or power generation schedules for the energy resources controlled by the respective external control centers 9-1, 9-2. The control center 5 is adapted to calculate for at least one monitored power grid parameter a power absorption schedule and/or power generation schedule for the batteries 2-i based on the deviation from a predetermined parameter target value of the at least one monitored power grid parameter. The power grid parameter can comprise an operation power supply frequency of an AC power supply grid 7. The monitored power grid parameter can also comprise a power supply voltage of the power supply grid 7.

In a possible embodiment, the control center 5 is adapted to receive duty power absorption schedules and/or power generation schedules for the entirety of batteries (2) from at least one external control center 9-i of the system 1.

In a further possible embodiment, the control center 5 is adapted to calculate switching schedules against planned power absorption schedules and/or power generation schedules for energy resources 8, 10, duty power absorption and/or power generation schedules for the batteries 2 and/or power absorption schedules and/or power generation schedules for the batteries 2 based on a deviation from a predetermined target value of at least one monitored power grid parameter. The control center 5 can be adapted to sum up at least one of the planned power absorption schedules and/or power generation schedules for the energy resources 8, 10 controlled by the at least one external control center 9-1, 9-2, the duty power absorption and/or power generation schedules for the batteries 2, the power absorption schedules and/or power generation schedules for the batteries 2 based on a deviation from a predetermined parameter target value of the at least one monitored power grid parameter to calculate a candidate schedule. The candidate schedule can then be optimized by the control center 5. The control center 5 can optimize the calculated candidate schedule on the basis of a utility of energy stored in the distributed batteries 2-i and/or life expectancy impacts of charging/discharging processes on the distributed batteries 2-i by varying the at least one planned power absorption schedule and/or power generation schedule for the energy resources 8, 10 controlled by the external control centers 9-1, 9-2 included in the summation.

In a further possible embodiment, the control center 5 is adapted to calculate a threshold per battery 2 of the deviation of the at least one grid parameter from the predetermined parameter target value. The control center 5 can calculate the thresholds for example through the following process:

i) identify the maximum power absorption required of the batteries 2 given the maximum expected oversupply of power and the corresponding deviation from a predetermined parameter target value of at least one monitored power grid parameter,
ii) identify the maximum allowable error of the maximum power absorption from i),
iii) define the first point in time for which the switching battery controllers 3 have not received a switching schedule yet as to,
iv) predict the power absorption for each battery 2 at t0 under the assumption that all low-frequency switches 3A are closed before t0,
v) select the battery 2 with the smallest predicted non-zero power absorption and remove it from the set of batteries,
vi) if no battery 2 could be selected in v), abort the process and force the selection of additional planned power absorption schedules before t0 of energy resources 8, 10 connected to external control centers 9,
vii) sum the predicted power absorptions of all selected batteries 2 at t0 provided that the low-frequency switches of the selected batteries 2 are closed,
viii) if the maximum power absorption from i) exceeds the sum of predicted power absorptions at t0 from vi), continue at iv),
ix) if the sum from iv) exceeds the maximum power absorption from i) by more than the maximum allowable overfulfillment from ii), abort the process and force the selection of additional planned power absorption schedules before t0 of energy resources connected to external control centers 9, x) determine the share of each selected battery 2 in the sum from vi),
xi) divide the interval between zero deviation of the grid parameter and the maximum deviation of the grid parameter into as many sub-intervals as selected batteries 2, each with a length proportional to the share of the battery 2 from x), xii) identify the thresholds of the selected batteries 2 with the boundaries of the sub-intervals from xi),
xiii) identify the thresholds of all other batteries 2 with infinity,
xiv) add the batteries 2 removed in viii) to the set of other batteries,
xv) calculate the switching schedules starting at t0 for the as in the case without the threshold calculation, but only taking into account the other batteries 2 and
xvi) perform i)-xiv) but for power generation instead of power consumption, where a battery 2 whose switching battery controller 3 opens the low-frequency switch 3A contrary to the switching battery controller's switching schedule is considered to have generated as much power as it was expected to absorb under the switching schedule.

The metering units 3D of the switching battery controllers 3 can be connected via a communication infrastructure to a virtual meter 12 of the central controller 5 as shown in FIG. 2.

In the illustrated embodiment, the batteries 2-i are connected to the associated switching battery controller 3 via a battery charger 4. The battery charger 4 can charge the respective battery 3 according to a predetermined charging program which may take different forms. The simplest form of a charging program is a constant power charge-up to an upper charge limit SOCₘₐₓ of the battery 2-i. All other components of the system 1 must not have knowledge of the charging program of the battery charger 4. The purpose of the system can still be achieved due to the power absorption prediction. This is because for the power supply grid 7, the state of charge of the batteries 2 has no technical significance, only the power absorption at every point in time has because it can lead to over- or undersupply of the power supply grid 7. This is a significant advantage of the system 1 according to the present invention because this allows the connection of different types of battery chargers 4 without establishing an information interface. It is possible to provide simply a connection to the one- or three-phase AC of the power supply grid 7. The distributed batteries 2-i can comprise rechargeable batteries of electric vehicles or other rechargeable batteries.

The local controller or processor 3B of the switching battery controller 3 can switch the low-frequency switch 3A according to the received switching schedule SCH. The switching schedule SCH can be fuzzy (e.g. “somehow, absorb 1 kWh between 22:00:00 and 22:15:00 on Jan. 1, 2018”) or very accurate or concrete (e.g. “switch on exactly at 22:00:34 on Jan. 1, 2018 and switch off exactly at 22:01:12 on Jan. 1, 2018”). Further, the switching schedule SCH can be a mixture including both fuzzy and concrete schedule elements which may not overlap in time. In the given example, the controller 3D of the switching battery controller 3 would close the low-frequency switch 3A at 22:00:00 on Jan. 1, 2018, then integrate the power measured by the metering unit 3D until 1 kWh has been absorbed and then open the low-frequency switch 3A. In a possible embodiment, the connection between the local controller 3B and the low-frequency switch 3A can be simple. For example, an electromechanical relay 3A can be connected via unshielded thin wires to the processor 3B of the switching battery controller 3. This provides an advantage because in conventional implementations of battery chargers, a high-frequency connection insulated or robust against electromagnetic disturbances is required. Furthermore, in high-frequency switching setups significant currents are transmitted into the power supply grid 7 at frequencies higher than the grid target frequency. Since this can disturb the operation of radio and information technology equipment as well as cause damage to rotating equipment, strict limits must be imposed on these currents. This requires elaborate electromagnetical filtering between the power supply grid 7 and every high-frequency switching setup, which the present invention dispenses with entirely due to its low switching frequency.

The communication network 6 can be formed by a low-bandwidth and high-latency communication infrastructure compared to conventional infrastructures used for controlling energy resources. This is possible because the system 1 according to the present invention does still work even for a signal transmission with relative high latency due to the capability of the local controller 3B of the switching battery controller 3 to accept fuzzy schedules SCH from the control center 5. This allows to use relative simple technological communication mechanisms such as GPRS which is a significant advantage of the system 1 according to the present invention.

The system 1 allows to stabilize the power supply grid 7 according to the operation frequency f of the grid and operating voltage U while charging the plurality of distributed batteries 2-i. The stabilization is achieved by balancing power fed into the power supply grid 7 and power drawn from the power supply grid 7 by energy consumers and the switching battery controllers 3-i. If a battery 2-i is not fully loaded the utility of the battery is diminished. For example, the driving range of an electric vehicle having an electric motor powered by a battery 2 is significantly reduced when the battery 2 is not charged completely. The battery is considered to be charged completely when the power prediction for the battery is reduced compared to its peak value by a factor of 3 or more. Further, the battery 2 is charged by the switching battery controller 3 energy-efficiently by taking into account optimal power operation points of the energy resources 8, 10. The optimal switching schedules for each switching battery controller 3 can be determined by the control center 5 using power predictions for all switching battery controllers 3-i and schedules offered by the external control centers 9-i.

FIG. 3 shows a flowchart of a possible exemplary embodiment of a method for efficient charging of distributed batteries according to a further aspect of the present invention. The distributed batteries are connected to a power supply grid via a low-frequency switch of a switching battery controller as illustrated in the system of FIG. 2. The method comprises in the illustrated embodiment two steps.

In a first step S1, power absorption predictions are calculated by a control center for all switching battery controllers in response to power measurements reported by the switching battery controllers to the control center.

In a further step S2, the low-frequency switch of a switching battery controller is controlled according to a switching schedule determined for the respective low-frequency switch by the control center on the basis of the calculated power absorption characteristics and on the basis of power absorption and/or power generation schedules of energy resources connected to the power supply grid.

The invention provides according to a further aspect a switching battery controller 3 for a rechargeable battery 2. A possible embodiment of the switching battery controller 3 according to an aspect of the present invention is illustrated in FIG. 2. The switching battery controller 3 comprises in the illustrated embodiment a low-frequency switch 3A connectable to the battery charger 4 of the rechargeable battery 2. The switching battery controller 3 further comprises in the illustrated embodiment a processor 3B adapted to control the low-frequency switch 3A according to a switching schedule SCH received from the control center 5 by a communication interface 3C of the switching battery controller 3. The switching battery controller 3 further comprises a metering unit 3D adapted to measure a current power absorbed by the battery charger 4 and to report the measured power absorption via the communication interface 3C of the switching battery controller 3 to the control center 5 of the system 1. In an alternative embodiment of the present invention, the metering unit 3D is adapted to measure the deviation of at least one grid parameter from its target value. In this alternative embodiment, the processor 3B is adapted to switch the low-frequency switch 3A contrary to the schedule received from the control center 5 if the deviation of the at least one grid parameter exceeds a threshold also received from the control center 5.

The invention further provides according to a further aspect a control center 5 for a system 1 as shown in FIG. 2. The control center 5 is adapted to provide a switching schedule SCH for different switching battery controllers 3-i on the basis of power absorption predictions calculated by a processing unit of the control center 5 for all switching battery controllers 3-i in response to power measurements reported by the different switching battery controllers 3-i and on the basis of power generation and/or absorption schedules of energy resources 8, 10 connected to the power supply grid 7. In an alternative embodiment, the control center 5 is adapted to additionally provide thresholds for the deviation of at least one grid parameter to different switching battery controllers 3-i on the basis of a maximum expected power absorption and/or generation of the entirety of batteries 2 at a predetermined maximum expected deviation of the at least one grid parameter. In this embodiment, the control center 5 is adapted so that the reaction of the entirety of batteries 2 to the deviation of the at least one grid parameter is approaching a predetermined continuous response function within the predetermined acceptable margin of overfulfillment.

In a possible implementation, the switching battery controller 3 can be integrated in a battery charger 4. The number and types of the batteries 2 can vary in different application scenarios. In a still further possible embodiment, several control centers 5-i can be provided for different groups of batteries communicating with each other via a private network 11. The system 1 allows for a fast charging of a plurality of distributed batteries 2 connected to the power supply grid 7 using the currently already operating energy resources 8, 10 connected to the power supply grid 7. The energy resources 8, 10 can further be operated at an operation point providing maximum efficiency. The energy resources 8, 10 comprise optimal operation points due to their technical implementation. For instance, a gas turbine power plant comprises a peak efficiency at full load. The system 1 according to the present invention comprising a control center 5 can make most efficient use of all already active energy resources reducing the necessity to ramp up additional energy resources during power consumption peak periods. Further, the number and capacity of necessary stand-by energy resources can be reduced in the system 1 according to the first aspect of the present invention.

1. A system for efficient charging of distributed batteries each connected to a power supply grid via a low-frequency switch of a switching battery controller communicating with a control center adapted to provide a switching schedule for the low-frequency switch of the respective switching battery controller on the basis of power absorption predictions calculated by said control center for the switching battery controllers in response to power measurements reported by the switching battery controllers and on the basis of power absorption schedules and/or power generation schedules of energy resources of said power supply grid.

2. The system according to claim 1, wherein the control center is adapted to determine the switching schedule for the low-frequency switch of the switching battery controller in response to the calculated power absorption predictions, the power absorption schedules and/or power generation schedules of the energy resources and in response to monitored power grid parameters.

3. The system according to claim 1, wherein the switching battery controller comprises a processor adapted to communicate with said control center via a communication interface of the switching battery controller and adapted to control the low-frequency switch of the switching battery controller according to the switching schedule determined by the control center for the low-frequency switch of the switching battery controller and received by said processor through the communication interface of the switching battery controller.

4. The system according to claim 1, wherein the switching battery controller comprises a metering unit adapted to measure a current power absorbed by a battery charger connected to the low-frequency switch of the switching battery controller and to report the measured power absorption to the control center which is adapted to calculate power absorption predictions based on previously reported power absorptions.

5. The system according to claim 1, wherein the control center is adapted to calculate power absorption predictions for a specific time period by evaluating previously reported absorptions of at least one corresponding time period in the past reported under matching circumstances.

6. The system according to claim 1, wherein the control center is connected to at least one external control center of energy resources to receive planned power absorption schedules and/or power generation schedules for the energy resources controlled by the respective external control center.

7. The system according to claim 2, wherein the control center is adapted to calculate for at least one monitored power grid parameter a power absorption schedule and/or power generation schedule for the batteries based on the deviation from a predetermined parameter target value of the at least one monitored power grid parameter.

8. The system according to claim 1, wherein the control center is adapted to receive duty power absorption schedules and/or power generation schedules for the entirety of batteries from at least one external control center.

9. The system according to claim 1, wherein the control center is adapted to calculate switching schedules against planned power absorption schedules and/or power generation schedules for energy resources, duty power absorption and/or power generation schedules for the batteries and/or power absorption schedules and/or power generation schedules for the batteries based on a deviation from a predetermined parameter target value of at least one monitored power grid parameter.

10. The system according to claim 6, wherein the control center is adapted to sum up at least one of the planned power absorption schedules and/or power generation schedules for the energy resources controlled by at least one external control center, the duty power absorption and/or power generation schedules for the batteries, the power absorption schedules and/or power generation schedules for the batteries based on a deviation from a predetermined parameter target value of at least one monitored power grid parameter to calculate a candidate schedule.

11. The system according to claim 10, wherein the control center is adapted to optimize the calculated candidate schedule on the basis of a utility of energy stored in the distributed batteries and/or life expectancy impacts of charging/discharging processes on the distributed batteries by varying the at least one planned power absorption schedule and/or power generation schedule for the energy resources controlled by at least one external control center included in the summation.

12. The system according to claim 1, wherein the low-frequency switch of a switching battery controller is an electromechanical switch.

13. The system according to claim 1, wherein the distributed batteries comprise rechargeable batteries of electric vehicles.

14. The system according to claim 4, wherein the metering units of the switching battery controllers are connected via a communication infrastructure to a virtual meter of the central controller.

15. A method for efficient charging of distributed batteries each connected to a power supply grid via a low-frequency switch of a switching battery controller,
the method comprising:
(a) calculating by a control center for all switching battery controllers power absorption predictions in response to power measurements reported by the switching battery controllers to the control center;
(b) controlling the low-frequency switch of a switching battery controller according to a switching schedule determined for the respective low-frequency switch by said control center on the basis of the calculated power absorption characteristics and on the basis of power absorption and/or power generation schedules of energy resources of said power supply grid.

16. A switching battery controller for a rechargeable battery said switching battery controller comprising:
(a) a low-frequency switch connectable to a battery charger of said rechargeable battery;
(b) a processor adapted to control the low-frequency switch according to a switching schedule received from a control center by a communication interface of said switching battery controller; and
(c) a metering unit adapted to measure a current power absorbed by the battery charger and to report the measured power absorption via the communication interface of said switching battery controller to said control center.

17. A control center for a system according to any of claim 1,
said control center being adapted to provide a switching schedule for different switching battery controllers on the basis of power absorption predictions calculated by said control center for all switching battery controllers in response to power measurements reported by the switching battery controllers and on the basis of switching schedules of energy resources of said power supply grid.
